(19) United States
(12) Patent Application Publication
(10) Pub. No.: US 2010/0169058 A1
(43) Pub. Date: Jul. 1, 2010

(54) MODELING STRUCTURE FOR SIMULATION OF TRAPEZOIDAL METAL LINE

(76) Inventors: Chan Ho Park, Goyang-si (KR); Won Young Jung, Nowon-gu (KR); Sung Gon Cho, Yangcheon-gu (KR)

Correspondence Address: SHERR & VAUGHN, PLLC, 620 HERNDON PARKWAY, SUITE 320, HERNDON, VA, 20170, US

(21) Appl. No.: 12/649,168

(22) Filed: Dec. 29, 2009

(30) Foreign Application Priority Data
Dec. 30, 2008 (KR) 10-2008-0136694

(51) Int. Cl. G06F 17/50

(52) U.S. Cl. 703/1

(57) ABSTRACT

Embodiments relate to a semiconductor technology, and more particularly, to a modeling structure for simulation of a trapezoidal metal line. The modeling structure for simulation of a trapezoidal metal line includes a top step with a width A, a bottom step with a width B, a middle step with a width equal to an average of the width A and the width B, and a total height C, wherein the middle step has a height equal to a value obtainable by subtracting both a height of the top step and a height of the bottom step from the total height C.

The present application claims priority under 35 U.S.C. 119 to Korean Patent Application No. 10-2008-0136694 (filed on Dec. 30, 2008), which is hereby incorporated by reference in its entirety.

### BACKGROUND

In general, one step in the design process for developing a semiconductor integrated circuit is to perform a simulation as to whether a designed circuit will operate properly or not, what is the performance of the circuit, what distribution and deviation will the performance of the circuit show, and then to feed a result of the simulation back to the design process.

Following gradual micronization of a modern semiconductor device structure, electric connection of metal lines have a small width to allow a high line density. Consequently, a simulation environment is useful, in which parasitic capacitance present at the connection of the metal lines that affects an operation rate of the device is analyzed accurately and quickly. Accuracy of the simulation may depend on a model used and its parameters. That is, in order to make an accurate simulation, an elaboration is important, in which limits of models are determined, and the parameters are fixed through accurate calibration.

In related fabrication technology over 0.25 micron for forming an interconnect line, a relatively large amount of loading effect takes places at the time of aluminum metal line fabrication, sloping sides of the metal line, thereby leading to form a metal line having a width different from a designed structure of a designer.

As the fabrication technology develops to below 0.25 micron, metal etching is developed, reducing the loading effect substantially. According to this, at the time, the sloped sides of the metal line do not have to be taken into account in modeling of the aluminum metal line. However, as the fabrication technology develops to the nano-technology, a size of a device becomes smaller, gradually reducing a metal line width and a space between lines, too. Due to this, an issue is developing, in which how well an insulating material is filled in the space between the metal lines. As one of methods for solving this, a slope is provided at a side surface of the metal line forcibly to form a metal line of a trapezoidal section, enabling the insulating material to be deposited thereafter in the space between the lines without any voids.

Therefore, in a simulation for making an accurate prediction of interconnect capacitance, modeling on a metal line of the trapezoidal section used in an actual semiconductor fabrication process, particularly, on the side slope, is beneficial.

### SUMMARY

Accordingly, embodiments relate to a modeling structure for simulation of a trapezoidal metal line. Embodiments relate to a modeling structure for simulation of a trapezoidal metal line, which can satisfy both a time period and accuracy of simulation in formulating a model to be used in 2D or 3D simulation. Embodiments relate to providing a modeling structure for simulation of a trapezoidal metal line, which can satisfy both a time period and accuracy of simulation in writing up inputs (a model) of the simulation for fabricating a metal line having a trapezoidal section with side slopes.

Embodiments relate to a modeling structure for simulation of a trapezoidal metal line that includes a top step with a width A, a bottom step with a width B, a middle step with a width equal to an average of the width A and the width B, and a total height C wherein the middle step has a height equal to a value obtainable by subtracting both a height of the top step and a height of the bottom step from the total height C.

In embodiments, each of the top step and the bottom step can have a height equal to ½ of a difference of the width B of the bottom step and the width A of the top step. The metal line can, for example, be formed of aluminum.

### DRAWINGS

FIG. 1 illustrates a section of a trapezoidal section of a related metal line.

FIG. 2 illustrates a model of a multiple stair type.

FIG. 3 illustrates a model of a medium width type.

FIG. 4 illustrates a model of a simple stair type.

FIG. 5 illustrates a model for describing a trapezoidal model in accordance with embodiments.

FIGS. 6A and 6B illustrate models each showing a trapezoidal model varied with a slope of sidewalls of a line in accordance with embodiments.

### DESCRIPTION

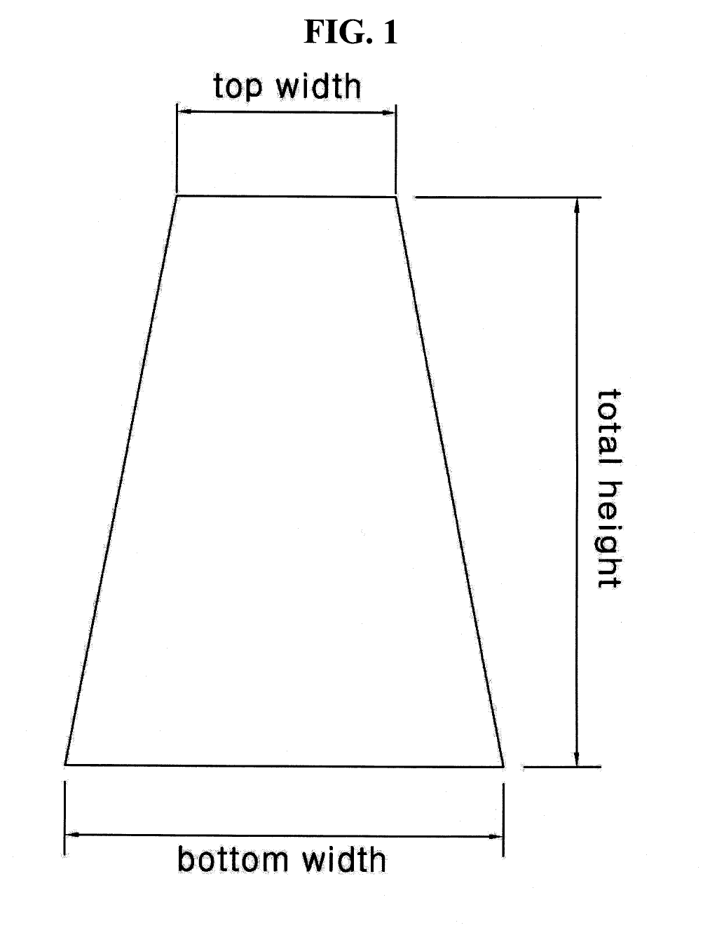

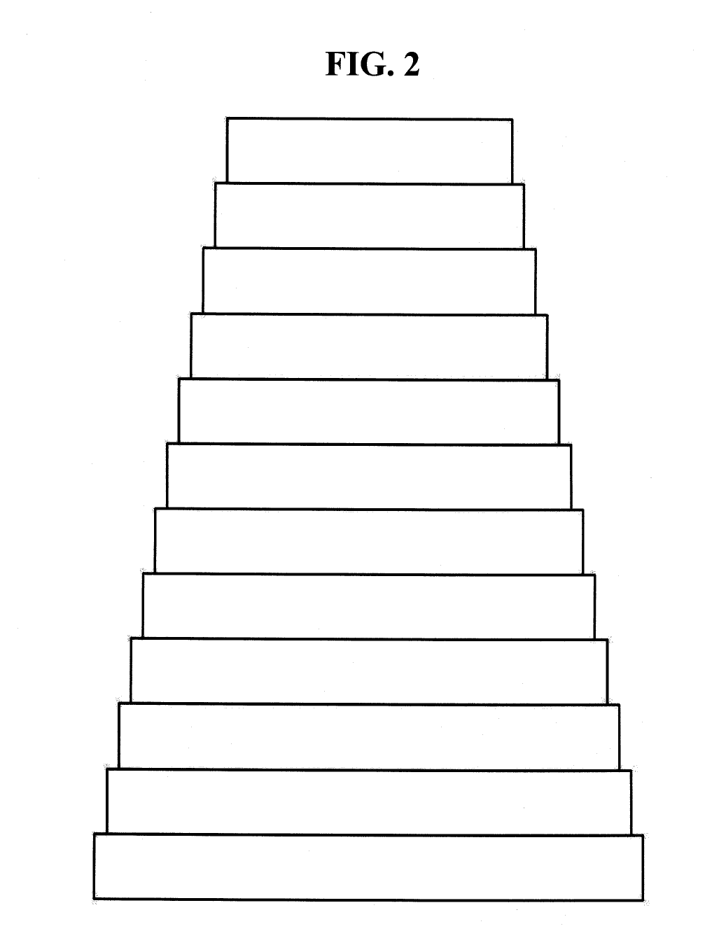

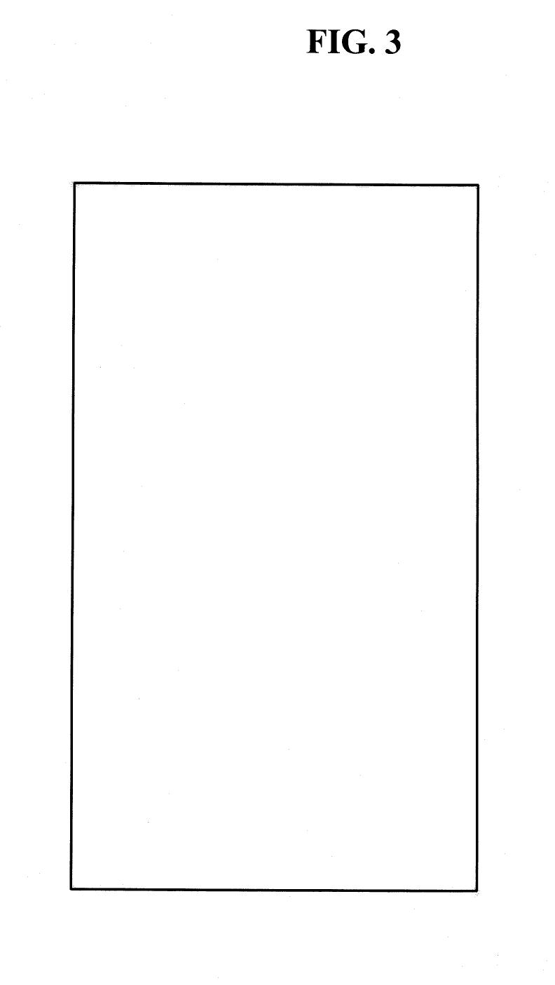

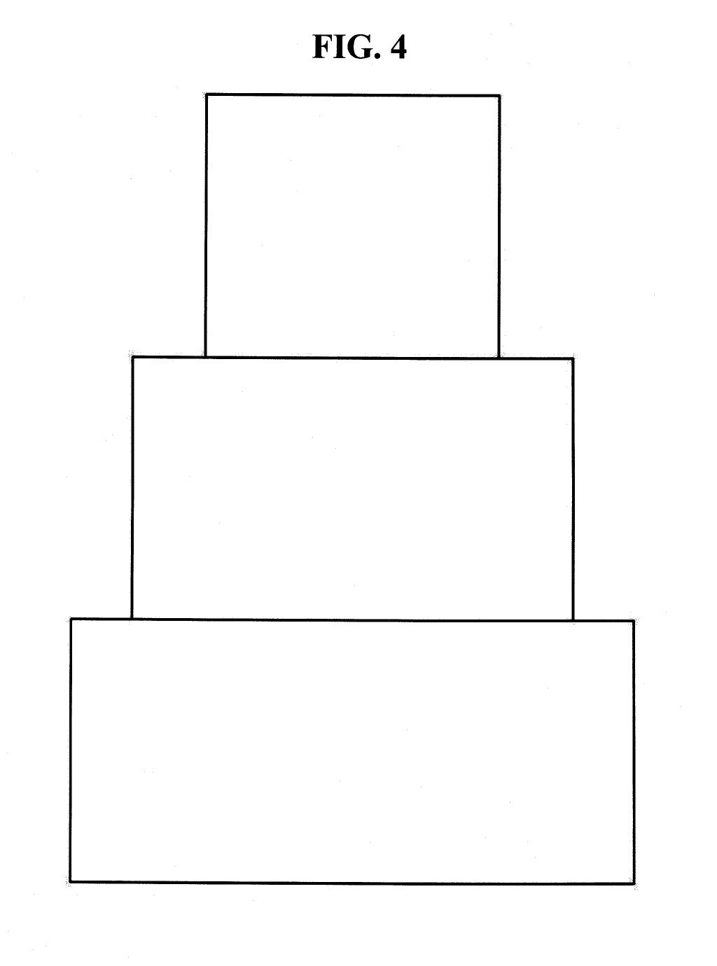

FIG. 1 illustrates a section of a trapezoidal section of a related metal line, FIG. 2 illustrates a model of a multiple stair type, FIG. 3 illustrates a model of a medium width type, and FIG. 4 illustrates a model of a simple stair type. Referring to FIG. 1, a general metal line has a trapezoidal cross section to some extent. As an example, a shape shown in FIG. 1 is a result of an aluminum metal line etching step controlled such that a top width is the same with an actual design structure and a bottom width is larger than the top width.

A multiple stair type shown in FIG. 2 is a trapezoid that can be configured for accurate simulation. Therefore, the multiple stair type is similar to a cross section of the metal line of an actual design structure enabling extraction of accurate values. However, since the multiple stair type can consume a large amount of simulation nodes, the multiple stair type may utilize relatively large amounts of time to put into practice.

A medium width type shown in FIG. 3 is a rectangle formed by using a medium value of a multiple stair type top width and a multiple stair type bottom width. Though the medium width type in FIG. 3 is advantageous in that the structure can be formed easily and simulation can be done quickly, the medium width type contains a large amount of error in calculation of capacitance in a vertical direction from the top width to the bottom width.

Embodiments of a trapezoidal metal line is possible for most 2-D simulations. On the other hand, though embodiments of the trapezoidal metal line is possible for 3-D simulations, the simulation may be carried out by using the medium width type or a simple stair type shown in FIG. 4 due to the calculation time period which is a result of the complexity of the multiple stair type. Though the medium width type may be mostly used for calculation of inter-coupling capacitance, and the simple stair type may be used for calculation of intra-coupling capacitance, the simple stair type fails to suggest an efficient structure.

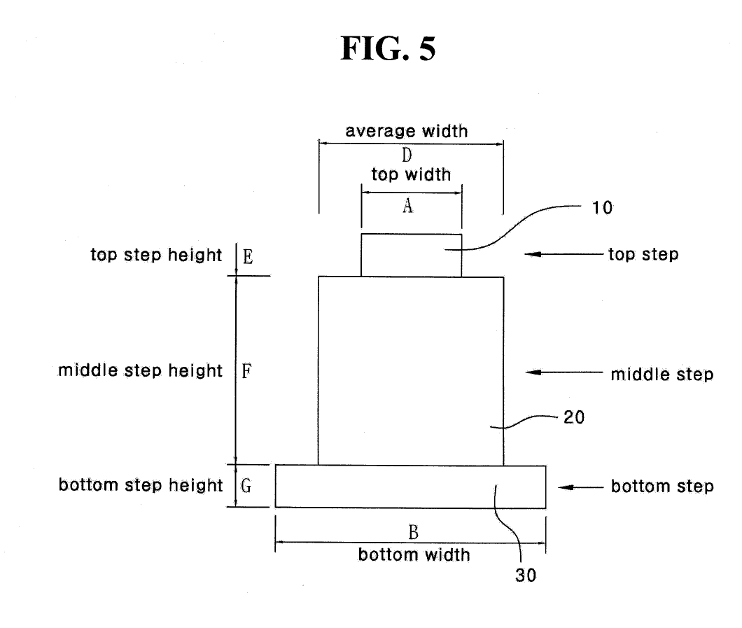

FIG. 5 illustrates a model for describing a trapezoidal model in accordance with a embodiments, which is an effective stair type trapezoid devised for embodying a cross section shown in FIG. 1.

In a case the trapezoid having the top width, the bottom width and the total height shown in FIG. 1 is designed, the effective stair type trapezoid is the most suitable model for simulation of the trapezoid. The effective stair type has three steps. A top step 10 of the effective stair type trapezoid has a width substantially the same as the top width of the actual design structure shown in FIG. 1, and a bottom step 30 thereof also has substantially the same as the bottom width of the actual design structure shown in FIG. 1.

A middle step 20 of the effective stair type trapezoid has a width which is substantially an average of the width of the top step 10 and the width of the bottom step 30. In this instance, the width of the top step 10 is substantially the same as the top width of the metal line shown in FIG. 1 and the width of the bottom step 30 is substantially the same as the bottom width of the metal line shown in FIG. 1.

Each of heights of the top step 10 and the bottom step 30 of the effective stair type trapezoid can vary with an angle of a slope of the actual metal line shown in FIG. 1, and the heights of the top step 10 and the bottom step 30 are substantially the same. That is, each of the heights can be about ½ of a width difference between the bottom step 30 and the top step 10, (i.e., each of the top step 10 and the bottom step 30 has a height equivalent to about ½ of a value obtainable when the width of the bottom step 30 is subtracted from the width of the top step 10.)

A height of the middle step 20 of the effective stair type trapezoid may have a value obtainable when both the height of the top step 10 and the height of the bottom step are subtracted from a height of the total metal line. That is, the height of the middle step 20 is a value obtainable when both the height of the top step 10 and the height of the bottom step are subtracted from a height of the total metal line shown in FIG. 1.

In summary, when it is assumed that the trapezoidal metal line in FIG. 1 has a top step with a width A, a bottom step with a width B which is different from, i.e., greater than A, and a height of C, the modeling trapezoidal metal line in FIG. 5 has a top step 10 with the width A, a bottom step with the width B, and a middle step 20 with a width which is substantially equal to an average, [A+B]/2, of the width A of the top step 10 and the width B of the bottom step 30. The middle step 20 may have a height substantially equal to a value obtainable by subtracting both a height of the top step 10 and a height of the bottom step 30 from the height C, and a height of each of the top step 10 and the bottom step 30 may be substantially equal to one half of a width difference of the width B of the bottom step 30 and the width A of the top step 10.

The following equations are examples of how to calculate the width of the middle step 20, the heights of the top step 10 and the bottom step 30 respectively, and the height of the middle step 20, respectively. Although the equations include an equal sign, according to embodiments, exact equality is not required.

A middle step width=[a top step width+a bottom step width]/2

A top step height=a bottom step height=[a bottom step width−a middle step width]/2

A middle step height=a total height−2[a top step height]=a total height−2[a bottom step height]

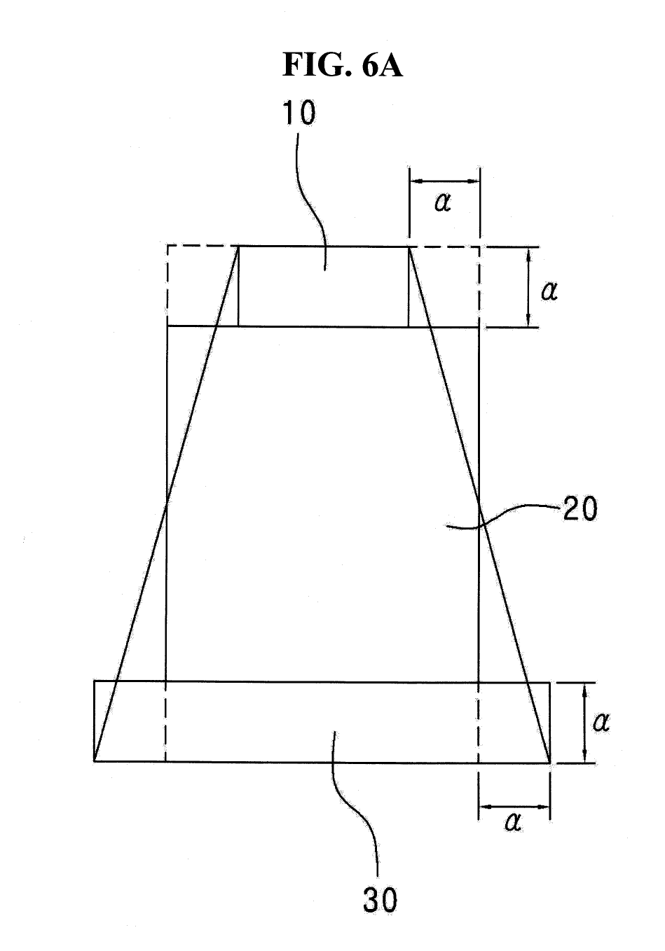

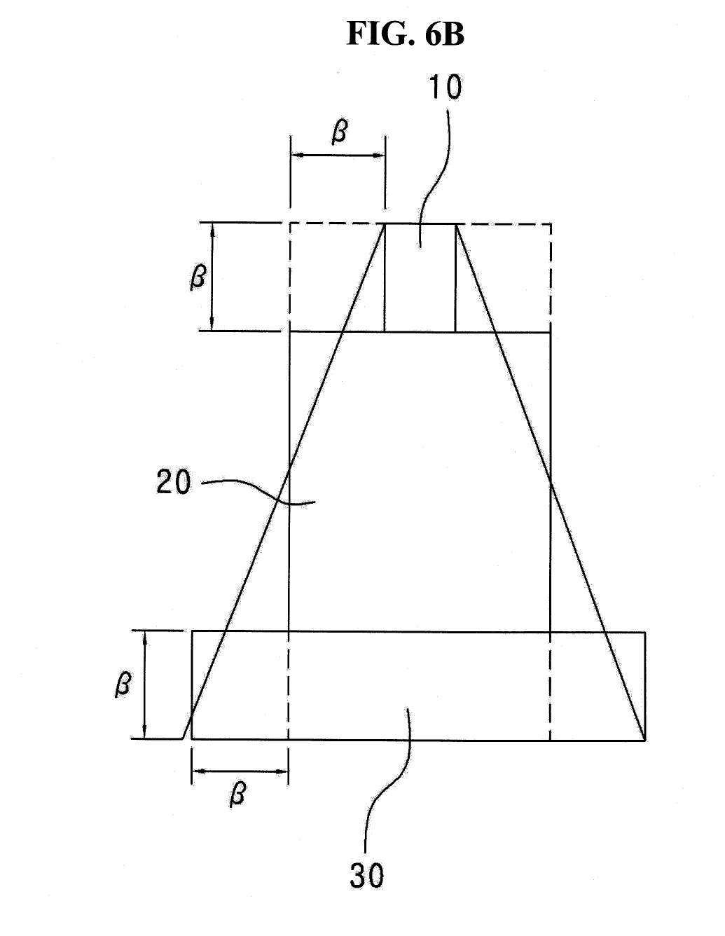

FIGS. 6A and 6B illustrate models each showing a trapezoidal model varied with a slope of sidewalls of a line. The trapezoidal models in FIGS. 6A and 6B show cross sections of the effective stair type set according to above equations in a case a sidewall slope of the metal line varies with different fabrication conditions even if the widths of the top steps of an actual design are the same, respectively. That is, the cross section can vary with an angle of the sidewall slope of the metal line, and by forming a shape similar to the cross section of the metal line to be formed actually, accuracy of the simulation can be improved.

Embodiments relate to applying the effective stair type trapezoid to design of simulation of a slope of a metal line taking place in an aluminum metal line forming process. The modeling structure for simulation of a trapezoidal metal line, in accordance with embodiments, satisfies both time period and accuracy of simulation in formulation of a 2-D or 3-D simulation model for fabrication of a metal line with a trapezoidal cross section and with a side slope and a width which becomes the greater as the trapezoid goes down toward a bottom.

By analyzing an operation frequency varied with current and voltage components in a semiconductor device which is being micronized gradually, accuracy of simulation can be improved in expression of an actual design. Embodiments can be applied to development of various tools.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. A modeling structure for simulation of a trapezoidal metal line comprising:
a top step with a width A;
a bottom step with a width B;
a middle step with a width equal to an average of the width A and the width B; and
a total height C.

2. The modeling structure of claim 1, wherein the width A of the top step is smaller than the width B of the bottom step.

3. The modeling structure of claim 1, wherein the middle step has a height substantially equal to a difference of both a height of the top step and a height of the bottom step substracted from the total height C.

4. The modeling structure of claim 1, wherein the top step has a height substantially equal to ½ of a difference of the width B of the bottom step and the width A of the top step.

5. The modeling structure of claim 1, wherein the bottom step has a height equal to ½ of a difference of the width B of the bottom step and the width A of the top step.

6. The modeling structure of claim 1, wherein the metal line comprises aluminum.

7. A method comprising:
simulating a trapezoidal metal line using a model structure that includes:
a top step with a width A;
a bottom step with a width B;
a middle step with a width equal to an average of the width A and the width B; and
a total height C.

8. The method of claim 7, wherein the width A of the top step is smaller than the width B of the bottom step.

9. The method of claim 7, wherein the middle step has a height substantially equal to a difference of both a height of the top step and a height of the bottom step substracted from the total height C.

10. The method of claim 7, wherein the top step has a height substantially equal to ½ of a difference of the width B of the bottom step and the width A of the top step.

11. The method of claim 7, wherein the bottom step has a height equal to ½ of a difference of the width B of the bottom step and the width A of the top step.

12. The method of claim 7, wherein the metal line comprises aluminum.

13. A system comprising:
a simulator configured to simulate a trapezoidal metal line using a model structure that includes:
a top step with a width A;
a bottom step with a width B;
a middle step with a width equal to an average of the width A and the width B; and
a total height C.

14. The system of claim 13, wherein the width A of the top step is smaller than the width B of the bottom step.

15. The system of claim 13, wherein the middle step has a height substantially equal to a difference of both a height of the top step and a height of the bottom step substracted from the total height C.

16. The system of claim 13, wherein the top step has a height substantially equal to ½ of a difference of the width B of the bottom step and the width A of the top step.

17. The system of claim 13, wherein the bottom step has a height equal to ½ of a difference of the width B of the bottom step and the width A of the top step.

18. The system of claim 13, wherein the metal line comprises aluminum.

19. The system of claim 13, wherein the simulator is configured to perform 2D simulation.

20. The system of claim 13, wherein the simulator is configured to perform 3D simulation.
